(19) United States
(12) Patent Application Publication
(10) Pub. No.: US 2011/0040137 A1
(43) Pub. Date: Feb. 17, 2011

(54) Automated mechanical cleaning method for radioactively contaminated metal

(76) Inventors: Chin-Hsiang Kan, Taoyuan County (TW); Tsong-Yang Wei, Taoyuan County (TW); Kou-Min Lin, Taoyuan County (TW)

Correspondence Address: MICHAEL LIN, 5F 79 Roosevelt Rd. Sec. 2, TAIPEI, 106, TW

(21) Appl. No.: 12/541,162

(22) Filed: Aug. 14, 2009

(51) Int. Cl. G21F 9/00

(52) U.S. Cl. 588/1

(57) ABSTRACT

A rotary-drum mechanical surface decontamination method for radioactively contaminated metal first places a feed chute fully loaded with radioactively contaminated metal on a hydraulic lift platform of a dual-chain roller conveyor and then moves the feed chute to a hydraulic cover-opening machine for positioning, and then uses a hydraulic cover-opening machine to open the cover of the feed chute, while non-covered feed chute will advance further to the post on a feed hopper of a drum spray washer, and then drop the workpieces into a conical drum for rotary multi-angular spray washing. The decontaminated metal waste is transferred by a vibrating discharger onto a conveyor and then into a discharge tank, and to the hydraulic cover-opening machine by a dual-chain roller conveyor, and to the hydraulic lift platform to complete the decontamination process.

### BACKGROUND OF THE INVENTION

1. Field of the Invention

The present invention is related to an automated mechanical cleaning method for radioactively contaminated metal. Especially it refers to an automated, simple, easy operating and effective surface cleaning method for radioactively contaminated metal.

2. Description of the Prior Art

When a nuclear facility is retired, it will leave many kinds of metallic radioactive wastes. The waste treatment is only to build warehouses to temporarily store and monitor the waste. There is increasing pressure on overloaded warehouses. To cope with nuclear facility retirement, it is necessary to properly clean the metallic radioactive waste to facilitate subsequent treatment. Traditional metallic radioactive waste treatment methods include manual feed-discharge-type mechanical sandblasting, ultrasonic cleaning, high-pressure water spray washing, dry ice spray washing, manual wipe cleaning, immersion-type chemical decontamination, electrolytic chemical decontamination etc. Under such an operation environment for a long period of time, the accumulation of radiation dose is likely to be harmful to human body. A relatively sound mechanical sandblasting decontamination method is for the operator to remotely operate the automatic spray washing equipment. Traditional mechanical decontamination equipment is laborious and requires metal hoist equipment to complete the decontamination process. It is unsafe and low yield. Although traditional equipment is inexpensive, the operator needs to be relatively closer to the equipment and is more prone to radiation. Practically there are drawbacks for inconvenient traditional method. Therefore, how to use safe and effective operation process to improve efficiency and prevent excessive accumulation of radiation dose is a very important subject.

In view of the drawbacks with traditional sandblasting decontamination method, the inventor has sought improvement and come up with the present invention.

### SUMMARY OF THE INVENTION

One objective for the present invention is to provide an automated mechanical cleaning method for radioactively contaminated metal; especially, a decontamination method for the radioactively contaminated metal waste temporarily stored in the warehouse. It is to apply proper surface decontamination to the radioactively contaminated metal wastes (including stainless steel, carbon steel, aluminum, copper . . . etc.) from retired nuclear reactor or other nuclear facility containing radioactive materials. This allows the reduction of radioactive contamination value to the criteria to remove the control. It will facilitate automation process and increase operation efficiency, reduce secondary waste. Moreover, the process is very simple and able to effectively lower the pressure on warehousing contaminated metal waste and make the operator exposure to radiation within controllable range.

To achieve the above objectives and functions, the adopted technical approaches include: putting the feed chute fully loaded with radioactively contaminated metal wastes on a hydraulic lift platform on a dual-chain roller conveyor (at this time the platform position is the lowest), transferring to a hydraulic cover-control machine to open the cover, transferring to a feed hopper of a drum spray washer, subject to positioning, lifting, flipping to a certain angle, and entering the drum spray washer where multi-angular spray washing is applied. The drum is in conical design with the advantage that is able to provide different appropriate tilt angles to different workpieces to be decontaminated, enabling rolling of the workpieces back and forth in the axial direction and obtaining desirable polishing decontamination effect. After cleaning, the workpiece is put on a conveyor by a vibrating discharger and moved up to the stainless steel discharge tank on the rollers. When the discharge tank automatically moves to the hydraulic cover-opening machine and gets positioned, the cover is descending to close the discharge tank and the entire unit advances to the hydraulic lift platform for positioning and subsequent transportation. All the above operations adopt programmable logic controller (PLC) to monitor and control all programs and also show all decontamination process flow through human-machine interface on a remote screen for the operator to complete all the decontamination process in a controllable fashion.

To make the above objectives, functions and features of the present invention substantially understandable, the following description is provided with illustrative figures.

### BRIEF DESCRIPTION OF THE DRAWINGS

FIG. 1 is the process flow diagram for the present invention.

FIG. 2 is the bird's eye view for the entire decontamination system of the present invention.

FIG. 3 is the side view for the entire decontamination system of the present invention.

FIG. 4 is the side view for the drum spray washer for the present invention.

### DESCRIPTION OF SPECIFIC EMBODIMENTS

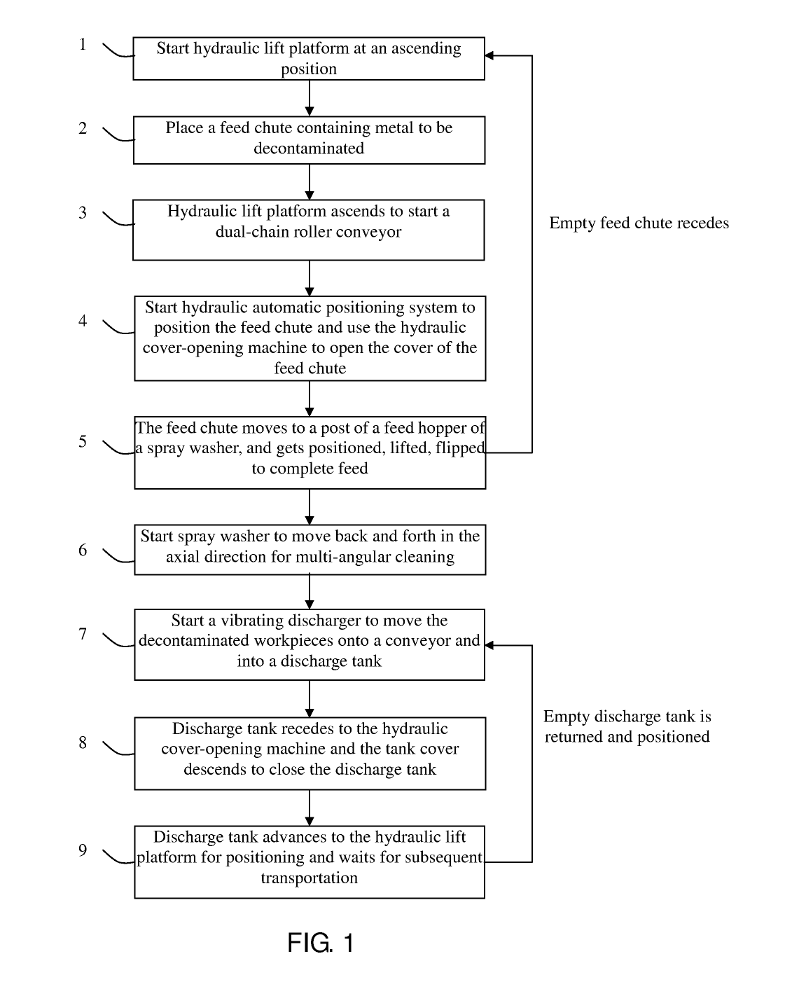

FIG. 1 shows the process flow for the present invention. It can be clearly seen that the major process for the present invention includes: Step 1: start the hydraulic lift platform 1 at an ascending point; Step 2: place the feed chute containing the metal to be decontaminated; Step 3: lower the hydraulic lift platform 1 and start the dual-chain roller conveyor 4; Step 4: start the hydraulic automatic positioning system 21 and after positioning the feed chute use the hydraulic cover-opening machine 2 to open the feed chute cover; Step 5: the feed chute gets positioned by a post when moving to the feed hopper of the drum spray washer 5, and subsequently lifted and flipped to complete feed; Step 6: start the drum spray washer 5 to move back and forth in the axial direction for multi-angular washing; Step 7: start the vibrating discharger 53 to transfer the decontaminated workpieces to the gradually rising conveyor belt 6 and discharge to the discharge tank; Step 8: when the discharge tank moves backward to the hydraulic cover-opening machine 2, the tank cover descends to close the discharge tank; Step 19: discharge tank moves forward to the hydraulic lift platform 1 and after being positioned waits for subsequent transportation; according to the above description, after Step 5 is completed, the empty feed chute follows the sequence opposite to the feed sequence from Step 1 to Step 5 to recede for repositioning; when Step 6 is in automatic mode, the drum spray washer 5 is operating in the following sequence: starting the hydraulic motor, roller ascending, safety door ascending, starting the fan, starting the roller, starting the lift, starting the screw, roller rotating forward, feed hopper ascending, feed hopper descending, safety door descending, turbine timing delayed, turbine starting, steel ball starting, timing, roller descending, roller ascending, and the process repeating in sequence until timing completed; Step 7: when the drum spray washer 5 stops, the vibrating discharger 53 starts to rotate and tilt with the movement of the drum spray washer 5; Step 7: the gradually rising conveyor belt 6 connects to the vibrating discharger 53 to receive the decontaminated workpieces and move the workpieces downward to the already positioned empty discharge tank that has been through Step 5.

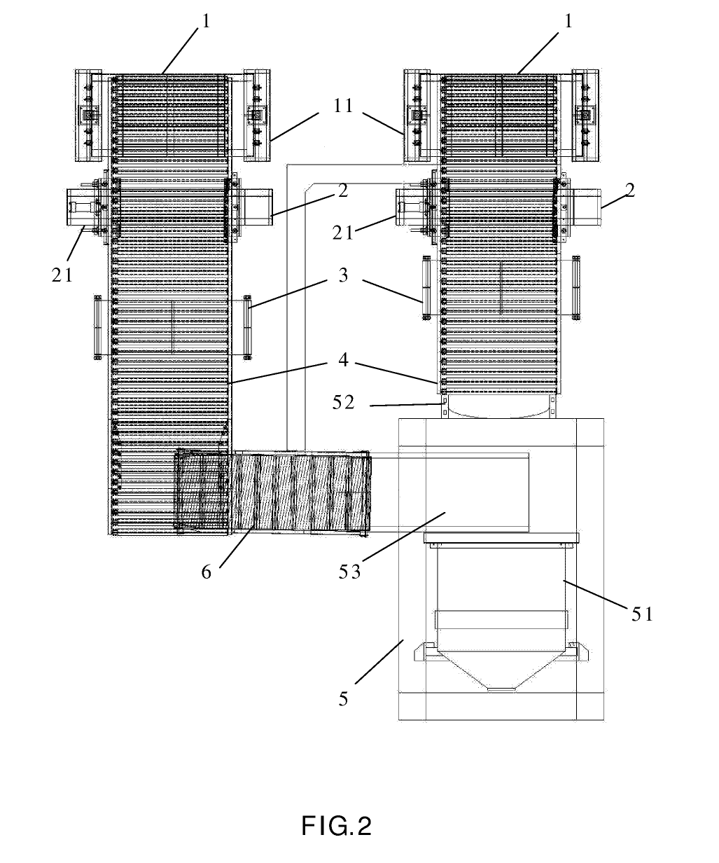

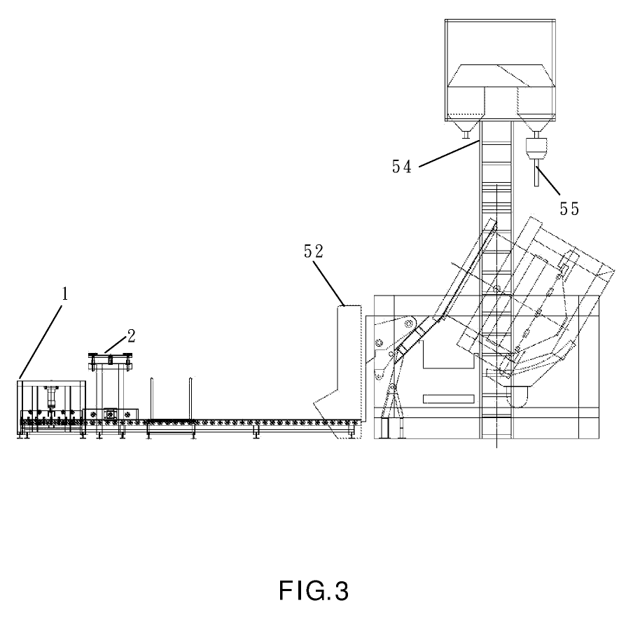

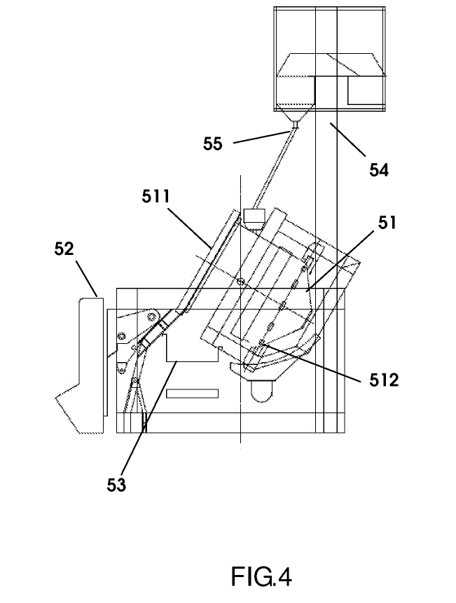

All the above steps are operating in automatic mode by a programmable logic controller (PLC) and indicate PLC signals on a screen through a remote human-machine interface during the decontamination process for the operator to monitor the status and control the system to achieve safe decontamination for radioactively contaminated metal. FIG. 2 is the bird's eye view for the entire decontamination system. FIG. 3 is the side view for the entire decontamination system. FIG. 4 is the side view for the drum spray washer 5.

In summary of the above description, the automated mechanical cleaning method for radioactively contaminated metal in the present invention can achieve automated operation to improve decontamination efficiency. The present invention is innovative and progressive. Therefore, a patent application is submitted. However, the above description is only a preferred embodiment for the present invention. Those extensions, modification, alteration or equivalent replacement based on the technical approaches and scope of the present invention shall fall into the range of claims by the present invention.

What is claimed is:

1. An automated mechanical cleaning method for radioactively contaminated metal at least comprises:
Step 1: start a hydraulic lift platform at an ascending point;
Step 2: place a feed chute containing metal to be decontaminated;
Step 3: lower a hydraulic lift platform and start a dual-chain roller conveyor;
Step 4: start a hydraulic automatic positioning system to position the feed chute and use a hydraulic cover-opening machine to open the feed chute cover;
Step 5: the feed chute moves to a post on a feed hopper of a spray washer to complete positioning, lifting, flipping and feeding;
Step 6: start spray washer to move back and forth in the axial direction for multi-angular cleaning;
Step 7: start a vibrating discharger to move decontaminated workpieces to a conveyor and then to a discharge tank;
Step 8: discharge tank recedes to a hydraulic cover-opening machine and the cover ascends to close the discharge tank; and
Step 9: the discharge tank advances to the hydraulic lift platform and after positioning waits for subsequent transportation.

2. The method of claim 1, wherein the Step 7 spray washer stops, the vibrating discharger starts to move with the spray washer rotating and tilting.

3. The method of claim 1, wherein the Step 7 conveyor connects to the vibrating discharger to receive decontaminated workpieces and moves downward the workpieces to the empty discharge tank, which follows the sequence opposite to the feed sequence from Step 1 to Step 5 to recede for repositioning.
